(19) United States
(12) Patent Application Publication
(10) Pub. No.: US 2023/0138513 A1
(43) Pub. Date: May 4, 2023

(54) TWIN PROPULSOR, PARALLEL HYBRID, STREAMLINED NACELLE PROPULSION SYSTEM

(71) Applicant: EMBRAER S.A., Sao Jose dos Campos - SP (BR)

(72) Inventors: Raphael Felipe Gama RIBEIRO, São José dos Campos - SP (BR); Ierko de MAGALHÃES GOMES, São José dos Campos - SP (BR); Rogério Kiyoshi MAKITA, São José dos Campos - SP (BR)

(21) Appl. No.: 17/972,309

(22) Filed: Oct. 24, 2022

Related U.S. Application Data
(60) Provisional application No. 63/273,257, filed on Oct. 29, 2021.

(51) Int. Cl. B64D 27/08; B64D 27/24; B64D 35/04

(52) U.S. Cl. CPC B64D 27/08; B64D 27/24; B64D 35/04; B64D 2027/026

(57) ABSTRACT

An aircraft with an aft-fuselage propulsion system comprises a thermal engine, a first electric motor coupled to a first propulsor, a second electric motor coupled to a second propulsor, and a mechanical interlink system integrating the thermal engine, the first electric motor, the second electric motor, plural battery systems and associated power electronics, and cabling elements connecting the electric machines. An aircraft has plural mirrored aft-fuselage propulsion systems, each aft-fuselage propulsion system comprising a thermal engine, an electric motor, a propulsor, and a mechanical interlink system integrating the thermal engine, electric motor, and propulsor elements.

### CROSS-REFERENCE TO RELATED APPLICATION

The present application claims the benefit of U.S. Provisional Application No. 63/273,257 filed Oct. 29, 2021, which is incorporated herein by reference in its entirety and for all purposes.

### FIELD

The technology herein relates to smaller aircraft propulsion systems, and more particularly to hybrid aircraft propulsion systems including electric motors and thermal engines. Still more particularly, the technology herein relates to placing electric motors in aircraft nacelles and linking them to a thermal engine such as a diesel piston engine in the aircraft fuselage.

### BACKGROUND & SUMMARY

The aviation industry is searching for alternatives to decrease the environmental footprint of its products. For smaller, commuter-class aircraft, propulsion electrification may be of special interest, since these aircraft have smaller payloads and shorter ranges, being potentially better matched with the lower specific energy (energy per weight ratio) of battery systems.

In the last few years, a considerable amount of work has been done on electrified propulsion systems.

For example, as shown in FIG. 1 of U.S. Pat. No. 9,878,796, a Gas turbine engine (20) drives a common shaft (33) with a clutching system (36) and an electric motor (38), which then drives a fan shaft (42). The system described in the '796 patent above was also patented in Europe, with different claims, also as represented by FIG. 1.

The '796 patent and its EP counterpart are limited to gas turbine engines. Gas turbine engines for commuter aircraft typically provide low thermal efficiency (<30%), mainly because the thermodynamic cycle is impacted by decreased rotating components efficiencies (compressors and turbines), the so-called “size effects”: larger relative tip clearances, lower Reynolds numbers and increased relative surface roughness. In contrast, example technology herein focuses on higher efficiency solutions, such as Diesel cycle, or compression-ignition engines. The system of FIG. 1 covers only gas turbine engines.

In addition, the '796 patent and its EP counterpart require a common shaft for the electric motor and clutch (36), namely that the turbine, said electric motor and said drive shaft of said, fan drive turbine driving said fan rotor through a common shaft. This was said to reduce complexity, thus providing an advantage over the prior art. In example non-limiting approaches herein, in contrast, the electric motor is either placed on the propulsor shaft or on a new shaft—not the same as the clutching system as installed for a gas turbine or other thermal engine. By doing so, shaft or electric motor failure modes can be better isolated.

The system of the '796 patent also requires a motor that transmits torque when it is shut down. The example non-limiting embodiments herein do not require such a system, since the electric motor is behind the propulsor shaft in the nacelles.

The system of the '796 patent opens the clutch at cruise altitudes. The herein described embodiments in contrast do the opposite, using preferably the thermal engines at cruise conditions to avoid large batteries, since cruise is typically the most energy-demanding flight phase.

Another hybrid drive solution is The Silent Air Taxi (SAT)—a modern aircraft for up to four passengers with a cruising speed of over 300 km/h and a range of more than 500 km, which is currently being developed by the e.SAT GmbH in Aachen Germany. It features a boxwing and a hybrid-electric (e) powertrain. This reportedly allows short take-off distances from almost any runway. The eSAT concept places the electric motors inside the fuselage. This location may bring some challenges to the motor thermal management: It is relatively close to the thermal engine and its exhaust system (high temperature environment). In addition, an air-cooled electric motor is harder to implement: it is close to the thermal engine. Additionally, it will not take credit from the increased dynamic pressure from the propulsor slipstream. eSAT concept foresees fixed-pitch blades with translating exhaust cone for propulsor flow control.

Another example hybrid propulsion system (WO2020104460) has a main gas turbine, an auxiliary gas turbine, and electric motors, which drive the aircraft propulsors. The system also foresees generators and electric storage systems. In contrast, example non-limiting technology herein focuses on thermal engines in a broader sense (of special interest, high-efficiency piston engines), and does not have an auxiliary gas turbine.

### BRIEF DESCRIPTION OF THE DRAWINGS

FIG. 1 shows an example prior art approach.

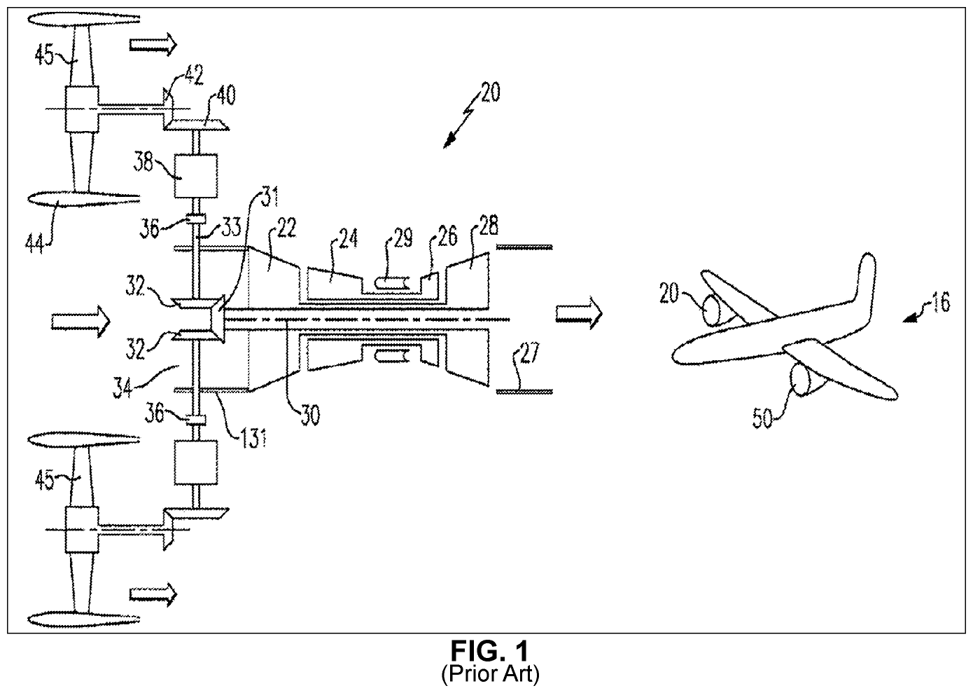

FIG. 2 shows example Pusher and Tractor arrangements.

FIG. 3 is an example non-limiting schematic diagram of Architecture #1.

FIG. 3A shows an example chart of operating modes for the FIG. 3 approach.

FIG. 4 is an example non-limiting schematic diagram of Architecture #2.

FIG. 5 is an example non-limiting schematic diagram of Architecture #3.

FIG. 5A shows an example chart of operating modes for the FIG. 5 approach

FIG. 6 is an example non-limiting schematic diagram of Architecture #4 schematics.

FIG. 6A shows an example chart of operating modes for the FIG. 6 approach.

FIG. 7A shows an example hardware block diagram of a control system.

FIG. 7B shows an example flowchart of control software executed by the FIG. 7A hardware.

### DETAILED DESCRIPTION OF NON-LIMITING EMBODIMENTS

The main technical problems to be solved are briefly discussed below along with proposed solutions:

Low battery specific energy: Fully electric aircraft are very limited in terms of range and speed, given low battery specific energy.

Proposed solution provided by example embodiments herein: Parallel hybrid propulsion system.

Thermal engine electrification challenges: Integrating an electric motor with a thermal engine often requires extensive hardware modifications on the engines themselves, leading to additional costs and development efforts.

Proposed solution provided by example embodiments herein: Integrate off-the-shelf systems (or systems with minimal adaptations) with a mechanical interlink system (purposely built gearboxes, shafts, and clutches).

Propulsive failure modes of a single-engine aircraft: Single engine aircraft lose all their propulsive power when the engine becomes inoperative.

Proposed solution provided by example embodiments herein: Add electric motors to the powertrain. With the use of clutches or other disconnect systems, additional redundancies can be built into the aircraft. For instance, in the case of the thermal engine failure, it could be disconnected, and the electric motors could then drive the propulsors.

Low thermal efficiency at low power settings: Thermal engines (especially gas turbine engines) typically offer low thermal efficiencies when operated at low power settings. This is especially important for short-haul aircraft, where taxi fuel consumption is an important proportion of the total block fuel.

Proposed solution provided by example embodiments herein: Add electric motors to the powertrain. With the use of clutches or other disconnect systems, the thermal engines can be disengaged and turned off in low power settings (for instance, during taxi-in and taxi-out phases). The electric motors alone can then provide the needed propulsive power in such phases. This solution can then provide zero or near-zero emissions at ground operations.

Large volume of higher efficiency thermal engines: More efficient thermal engines (such as Diesel cycle engines) tend to present lower power densities (power to volume ratio) and lead to nacelles with higher volume and drag.

Proposed solution provided by example embodiments herein: Install the thermal engines on the aft fuselage.

Electric Powertrain Thermal Management System (TMS) integration: Integrating a TMS to the electric powertrain on a nacelle that contains a thermal engine of large volumes leads to even higher nacelle volume, weight, and drag.

Proposed solution provided by example embodiments herein: Install the electric motors on aft fuselage-placed nacelles. In a pusher propulsor arrangement, ram air dynamic pressure potentially enables air-cooled electric motors, which are simpler and do not require a complex, liquid-cooled TMS. In a tractor arrangement, the ram air pressure is further boosted by the propulsor slipstream, which can be of special interest during low forward speed conditions, such as taxi and the initial take-off run.

Need to decrease aircraft noise: Customer requirements for lower noise propeller-driven aircraft (internal & external) will be hardly met with conventional propulsion installation (e.g., engines and propellers on the wings or on the aircraft forward fuselage)

Proposed solution provided by example embodiments herein: Install the propulsors on the aft fuselage, decreasing the cabin noise. Decrease propulsor disk loading (through the use of two propulsors instead of one, which is the typical solution of single engine turboprops, leading to a larger total disc area for a given shaft power, increasing the propulsor induced efficiency) and blade loading (lower power per blade), reduces external noise.

Additional non-limiting characteristics provided by example embodiments herein include:

Thermal engine starting: High torque thermal engines may require bulky starting systems (usually a battery-driven electric starter/generator). The mechanical link between the thermal engine and electric motors may enable the use of the propulsive electric motors themselves to start the thermal engine, potentially offering weight and costs reduction, as well as increased starting capabilities (torque and driving time).

An architecture that places the electric motors in the nacelles, aiming to facilitate the integration of air-cooled motors (“clean” ram air and/or propulsor wash).

Variable pitch propulsors with fixed exhaust cone (if propulsor is ducted).

Reduced environmental footprint aircraft, enabled by:
a) Cruise-sized and optimized thermal engine, which can be of any type, with increased interest on Diesel cycle or compression-ignition piston engines. These engines may offer 50% lower power specific fuel consumption than gas turbines of similar power classes.
b) Electric taxi, reducing ground emissions.
c) Electrically boosted take-off and climb segments, allowing the cruise optimization of the thermal engine.
d) Some portions of the cruise phase can also have an electric power boost, depending on attainable battery specific energy (energy to weight ratio).
e) Nacelles with lower weight and drag, sized to house the electric motors, and not the thermal engine. The larger thermal engine is housed within the aircraft fuselage.
f) Lower propulsor disk loading (higher propulsor disk area when compared to single-engine, single propulsor aircraft, for a given shaft power value), leading to increased propulsor efficiency, especially at low speeds, and decreased propulsor noise.
g) Concept future-proofing: as battery technology evolves, lighter and cheaper batteries could be installed, increased the hybridization degree and further reducing the aircraft environmental footprint.

Better integration with electric powertrain thermal management system
a) The propulsor wash offers increased airflow and dynamic pressure for cooling systems.
b) Placing the electric motor behind the propulsor potentially enables the use of air-cooled motors, which are simpler and less expensive than liquid-cooled ones.
c) If liquid-cooled motors are needed, the propulsor flow can be used to cool heat exchangers.

Increased Redundancy:
a) Architectures #1 to #3 described below offer greater redundancy when compared to single-engine, single propulsor aircraft. The use of one thermal engine, two electric motors and two propulsors which can be selectively coupled to each other enables the utilization of different operational strategies, providing the aircraft with propulsive power in the case of an individual failure of the thermal engine, electric motor or propulsor.
b) Architecture #4 described below offers greater redundancy when compared to twin-engine, twin propulsors aircraft, using two thermal and two electrical motors.
c) The electric motors can be used to start the thermal engine (ground and flight operations). These motors coupled to the propulsion batteries can provide greater starting torque and for a prolonged time, when compared to smaller starter/generator and associated start battery.

Example Non-Limiting Architectures

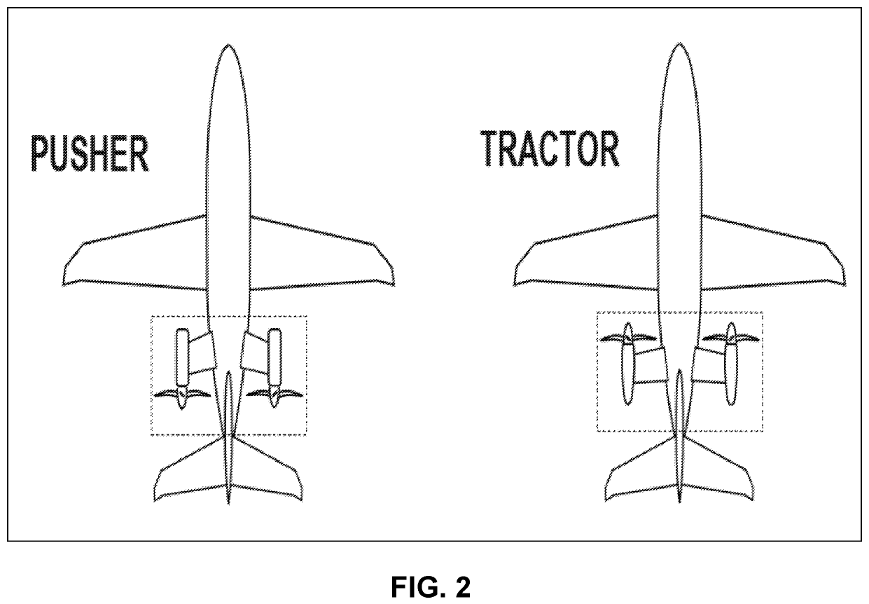

The solutions discussed above are implemented in the architectures presented in the sections below. The shown example non-limiting architectures consider a tractor propulsor arrangement (see FIG. 2), but the same architectures could be adapted to a pusher arrangement, by rearranging the sequence of the elements within the nacelles.

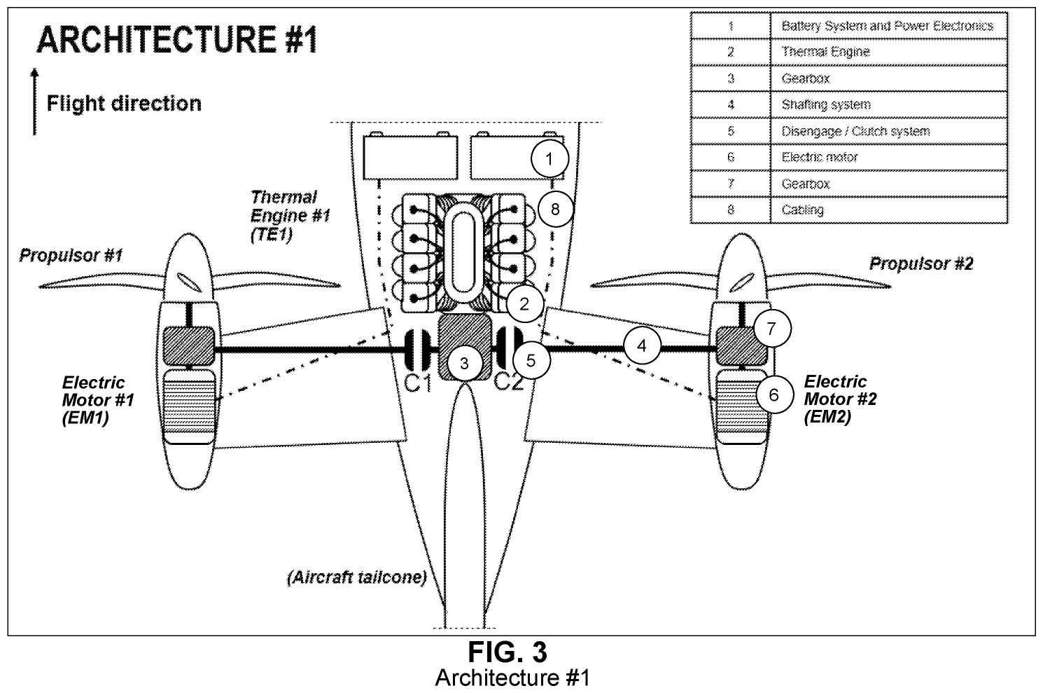

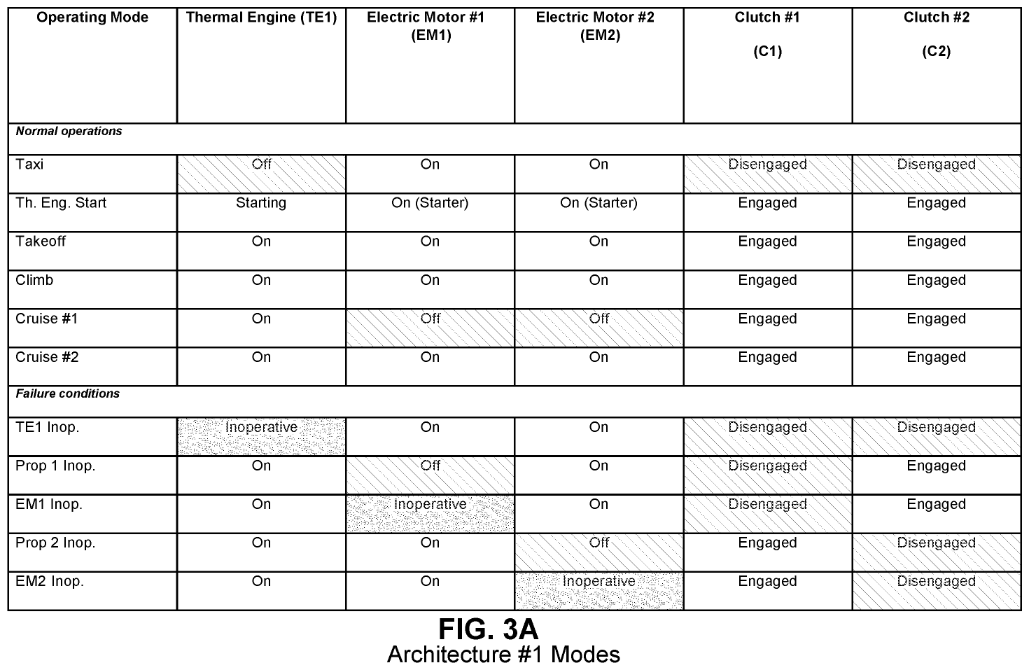

A schematic layout of an example embodiment (architecture #1) is shown in FIG. 3; main components are listed from (1) to (8). Power electronics that condition the electric power between the energy source (battery) and electric motors are not explicitly shown in the layouts, since they could be placed anywhere in the aircraft, within the nacelles, pylons, or fuselage, depending on the considered technological solutions.

| | |
|---|---|
| 1 | Battery System and Power Electronics |
| 2 | Thermal Engine |
| 3 | Gearbox |
| 4 | Shafting System |
| 5 | Disengage/Clutch System |
| 6 | Electric Motor |
| 7 | Gearbox |
| 8 | Cabling |

A thermal engine (2), which can be of any type, but preferably is a Diesel cycle piston engine, is located in the fuselage of the aircraft. The thermal engine (2) drives a reduction gearbox (3), which can be of fixed or variable gear ratio, and is connected to a second set of gearboxes (7) through clutches (5) C1 and C2, which may be passive or actuated clutches, and shafts (4). The system is electrified by adding battery systems (two different systems for increased redundancy) and power electronics (1), electric cables (8) and electric motors (6).

Electric motors (EM1, EM2) (which in some embodiments may comprise power electronics as described above) are placed in the nacelles behind the propulsors and associated gearboxes (7), in order to take advantage of the improved airflow induced by the propulsors. Such placement facilitates the integration of air-cooled motors using “clean” ram air and/or propulsor wash. The embodiments herein provide for lower propulsor disk loading (higher propulsor disk area when compared to single-engine, single propulsor aircraft), leading to increased propulsor efficiency, especially at low speeds, and decreased propulsor noise.

Each gearbox 7, which can be of fixed or variable gear ratio, can couple rotational power a respective electric motor produces to a respective propulsor, and can also couple power the thermal engine 2 produces (transmitted through gearbox 3, clutches 5) to the propulsor. Clutches C1, C2 may be passive or actuated clutches and can be operated independently so the thermal engine 2 may output power to one propulsor, the other propulsor, or both propulsors. The gearbox 7 output shafts drive respective propulsors, which can be unducted, such as propellers having variable, controllable pitch, or ducted, which may also have controlled pitch and fixed exhaust cone. In addition to driving the propulsors, the electric motors can also be used to start the thermal engine, increasing ground and flight (in case of thermal engine failure) starting (or re-starting) capabilities.

Potential operating strategies and failure conditions for this architecture are summarized in Table 1 below and FIG. 3A.

TABLE 1
Architecture #1 Operating Modes.

| | | | | | |
|---|---|---|---|---|---|
| | Thermal | Electric | Electric | | |
| | Engine | Motor #1 | Motor #2 | Clutch #1 | Clutch #2 |
| Operating Mode | (TE1) | (EM1) | (EM2) | (C1) | (C2) |

Normal operations

| | | | | | |
|---|---|---|---|---|---|
| Taxi | Off | On | On | Disengaged | Disengaged |
| Th. Eng. Start | Starting | On (Starter) | On (Starter) | Engaged | Engaged |
| Takeoff | On | On | On | Engaged | Engaged |
| Climb | On | On | On | Engaged | Engaged |
| Cruise #1 | On | Off | Off | Engaged | Engaged |
| Cruise #2 | On | On | On | Engaged | Engaged |

Failure conditions

| | | | | | |
|---|---|---|---|---|---|
| TE1 Inop. | Inoperative | On | On | Disengaged | Disengaged |
| Prop 1 Inop. | On | Off | On | Disengaged | Engaged |
| EM1 Inop. | On | Inoperative | On | Disengaged | Engaged |
| Prop 2 Inop. | On | On | Off | Engaged | Disengaged |
| EM2 Inop. | On | On | Inoperative | Engaged | Disengaged |

As the chart reflects, the electric motors can drive the respective propulsors during taxiing under battery power. Then, to start the thermal engine, the clutches C1 and/or C2 can be engaged so the rotational power produced by the electric motor(s) can drive the crankshaft of the thermal engine in order to start the engine. For takeoff, the electric motors continue to provide power to the propulsors, and the thermal engine now supplements that power to provide increased torque for the propulsors for takeoff and subsequent climb. Once the aircraft reaches cruise altitude, the thermal engine can continue to power the propulsors without the electric motors, or the electric motors can continue to power the propulsors without the thermal engine, depending on particular conditions and operations such as desired air speed, turbulence, etc. Some portions of the cruise phase can also have an electric power boost depending on battery size, recharging rate, etc.

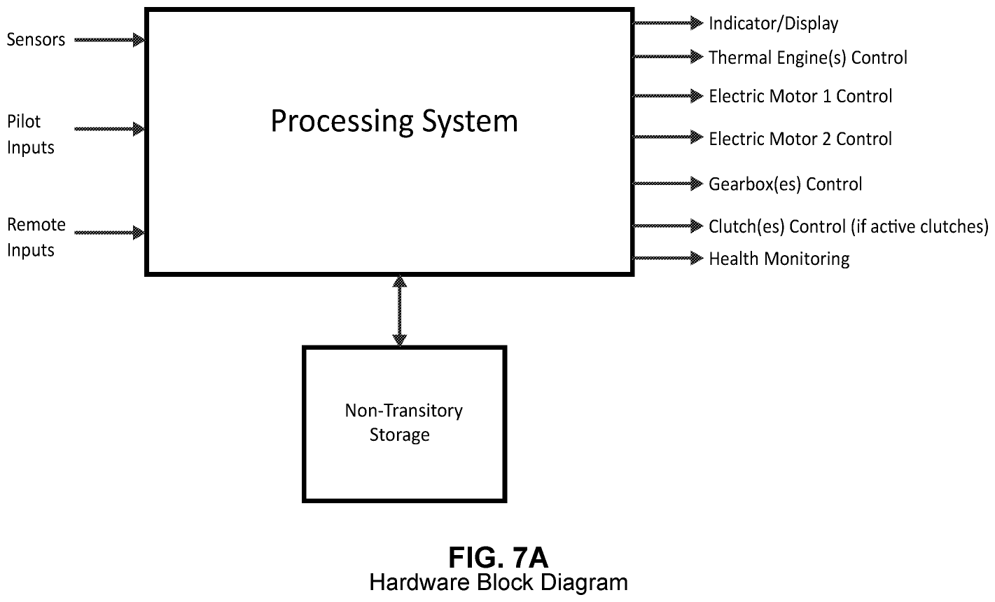

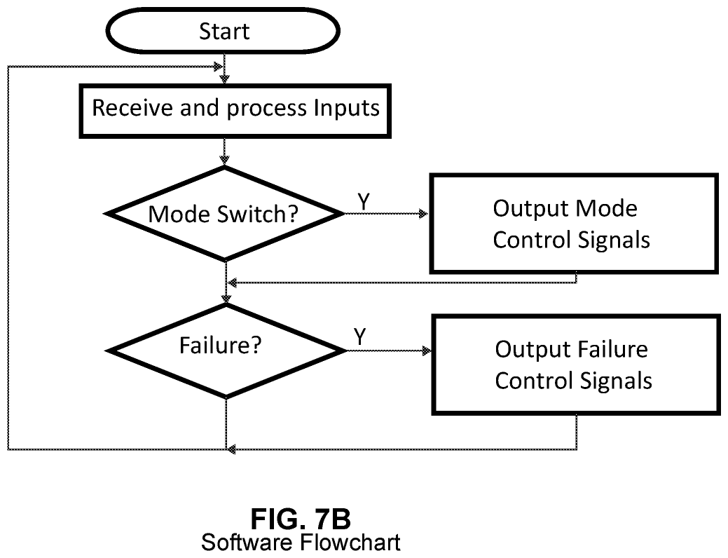

The example chart also shows certain failure conditions and associated automatic control responses of an example system. For example, if the thermal engine ceases to function, the aircraft can use the electric motors instead to maintain flight. Similarly, if either electric motor fails, the thermal engine and the other electric motor can be used to provide power. A control system such as a processor connected to non-transitory memory storing software (see FIGS. 7A, 7B) may be used to check for such failures, and to automatically provide indications and appropriate control signals to control operating modes of various components such as clutches C1, C2, gearboxes, etc.

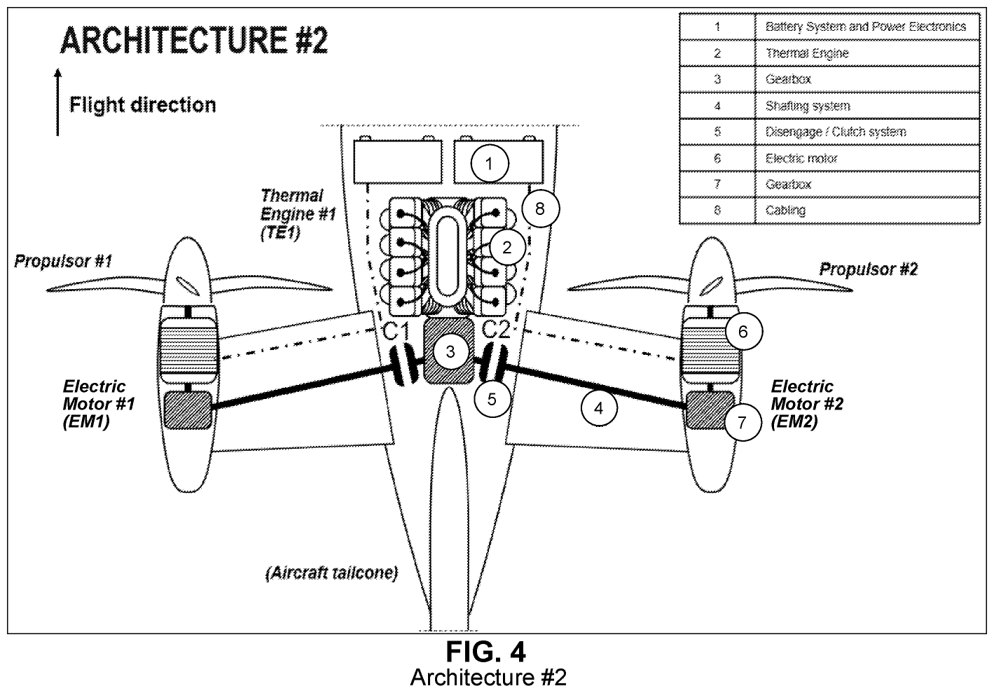

A schematic layout of another embodiment (architecture #2) is shown in FIG. 4. The basic difference from the FIG. 3 Architecture #1 is that the electric motor (6) is now placed between the gearbox (7), which can be of fixed or variable gear ratio, and the propulsor. By doing so, the system can be simplified, since it needs a lower number of parts (the electric motor (6) rotor is used to transmit torque from the gearbox (7) to the propulsors, avoiding the need for additional shafts and bearings: the electric motor and the propulsor may share common bearings). The placement of the electric motor closer to the propulsor brings the thermal management advantages previously discussed (clean airflow or boosted airflow from the propulsor slipstream). The operating modes and failure mode conditions are presented in Table 1 and FIG. 3A and are the same as for the FIG. 3 embodiment.

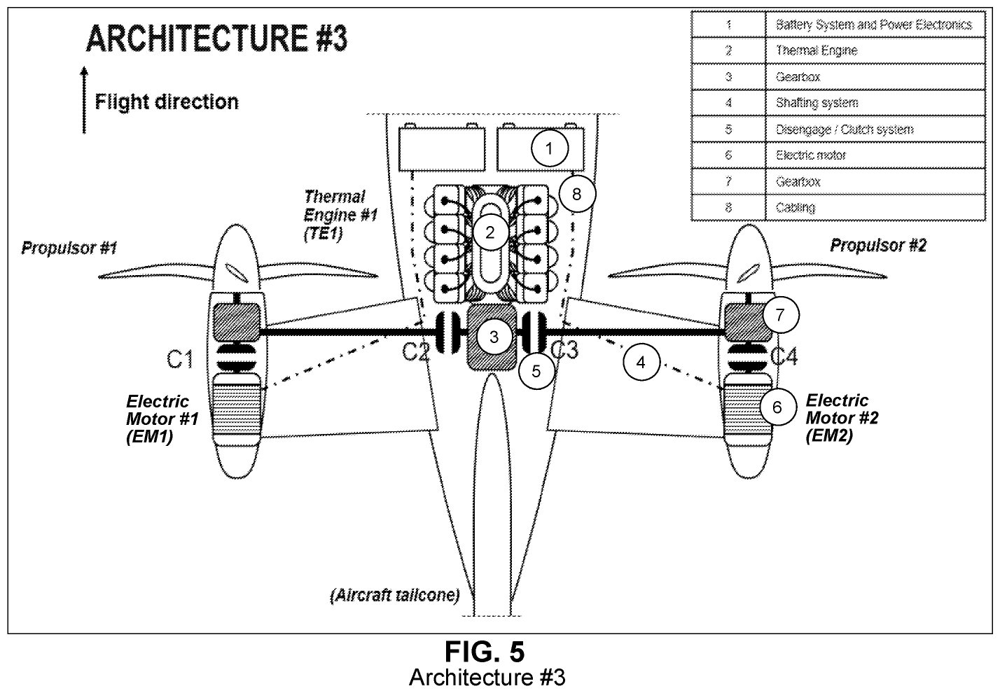

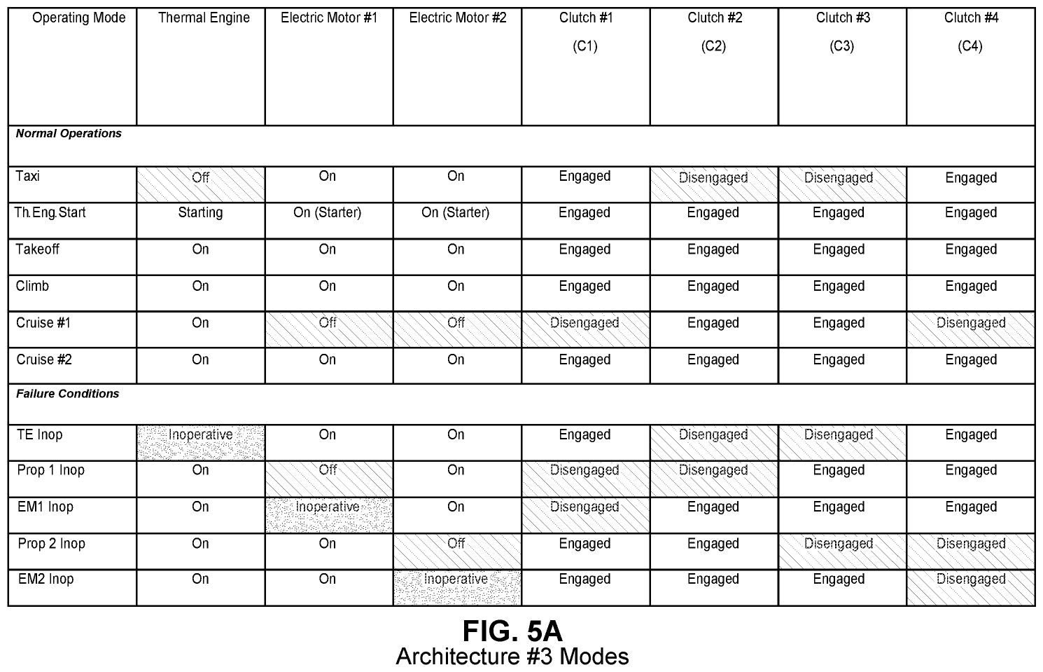

Another embodiment (Architecture #3) is schematically presented in FIG. 5. Architecture #3 is similar to Architecture #1 of FIG. 3, with the addition of clutches (C1 and C4), which may be passive or actuated clutches, between the electric motors (6) and the propulsor gearbox (7), which can be of fixed or variable gear ratio. Thus, in this case, clutches C1, C2 in FIG. 3 are relabeled C2, C3, and additional clutches C1 and C4, which may also be passive or actuated clutches, are provided in the nacelles between the electric motors 6 and nacelle gearboxes 7. By doing so, a failed electric motor can be mechanically disconnected from the powertrain, allowing both propulsors to be driven by the remaining motors and/or engines. This can increase efficiency by reducing the mechanical damping caused by a failed electric motor and also protect against an electric motor failure mode in which the electric motor shaft becomes locked. The operating strategies, for both normal and failure conditions, are provided in Table 2 and FIG. 5A.

TABLE 2
Architecture #3 Operating Modes.

| | | | | | | | |
|---|---|---|---|---|---|---|---|
| Operating | Thermal | Electric | Electric | Clutch #1 | Clutch #2 | Clutch #3 | Clutch #4 |
| Mode | Engine | Motor #1 | Motor #2 | (C1) | (C2) | (C3) | (C4) |

Normal Operations

| | | | | | | | |
|---|---|---|---|---|---|---|---|
| Taxi | Off | On | On | Engaged | Disengaged | Disengaged | Engaged |
| Th. Eng. Start | Starting | On (Starter) | On (Starter) | Engaged | Engaged | Engaged | Engaged |
| Takeoff | On | On | On | Engaged | Engaged | Engaged | Engaged |
| Climb | On | On | On | Engaged | Engaged | Engaged | Engaged |
| Cruise #1 | On | Off | Off | Disengaged | Engaged | Engaged | Disengaged |
| Cruise #2 | On | On | On | Engaged | Engaged | Engaged | Engaged |

Failure Conditions

| | | | | | | | |
|---|---|---|---|---|---|---|---|
| TE1 Inop | Inoperative | On | On | Engaged | Disengaged | Disengaged | Engaged |
| Prop 1 Inop | On | Off | On | Disengaged | Disengaged | Engaged | Engaged |
| EM1 Inop | On | Inoperative | On | Disengaged | Engaged | Engaged | Engaged |
| Prop 2 Inop | On | On | Off | Engaged | Engaged | Disengaged | Disengaged |
| EM2 Inop | On | On | Inoperative | Engaged | Engaged | Engaged | Disengaged |

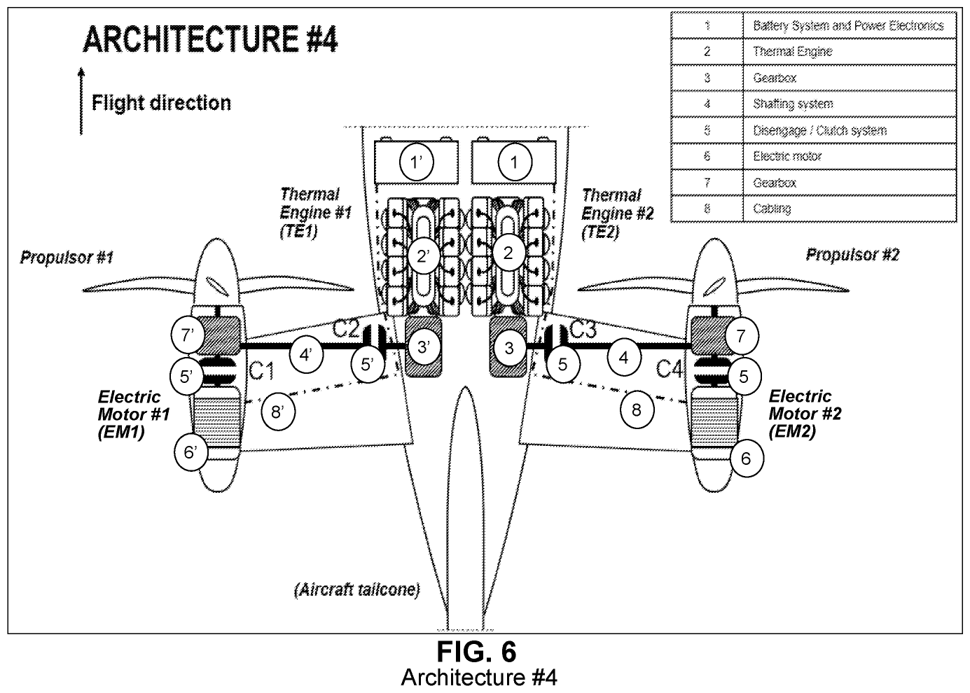

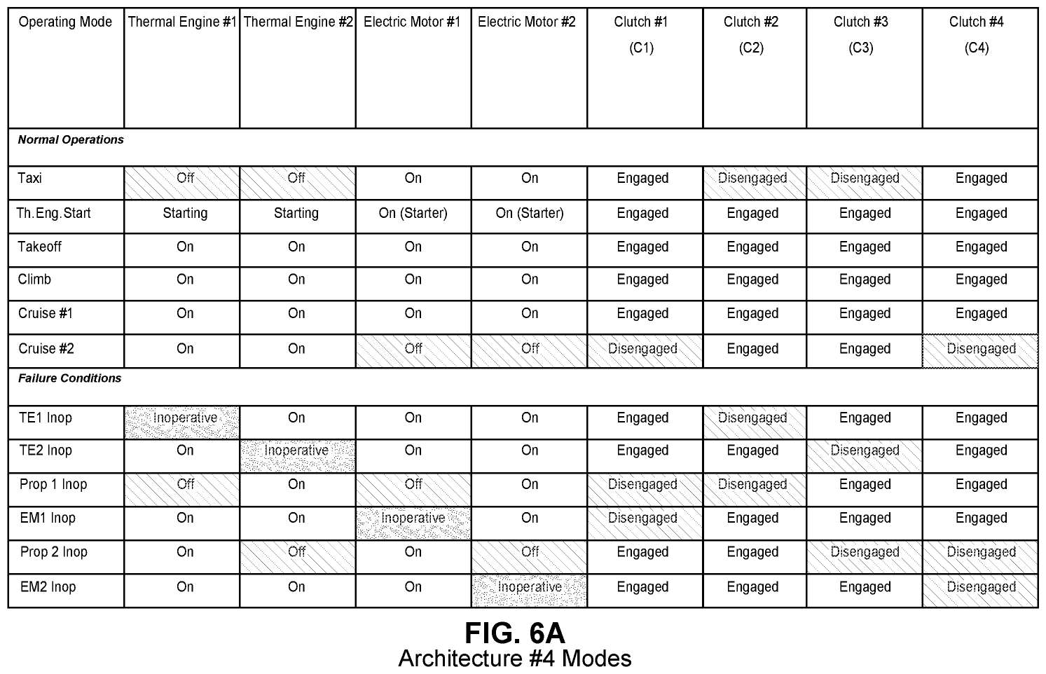

Architecture #4 in FIG. 6 below shows an embodiment with two mirrored propulsion systems, each comprising: an electric battery, a thermal engine (2, 2′) coupled to a reduction gearbox (3, 3′), which can be of fixed or variable gear ratio, and provides torque to a clutch (5, 5′), which may be passive or actuated, and a driveshaft (4, 4′), which drives a secondary gearbox (7, 7′), which can be of fixed or variable gear ratio, to which an electric motor (6, 6′) is coupled through a clutch (5, 5′), which may also be passive or actuated. The propulsor gearbox (7, 7′) output shaft then drives the aircraft propulsors. The embodiment of Architecture #4 provides additional power (using two thermal engines) and redundancies (two independent propulsion branches) with corresponding failsafe operation. The operating strategies are presented in Table 3 and FIG. 6A.

TABLE 3
Architecture #4 Operating Modes.

| | | | | | | | | |
|---|---|---|---|---|---|---|---|---|
| Operating | Thermal | Thermal | Electric | Electric | Clutch #1 | Clutch #2 | Clutch #3 | Clutch #4 |
| Mode | Engine #1 | Engine #2 | Motor #1 | Motor #2 | (C1) | (C2) | (C3) | (C4) |

Normal Operations

| | | | | | | | | |
|---|---|---|---|---|---|---|---|---|
| Taxi | Off | Off | On | On | Engaged | Disengaged | Disengaged | Engaged |
| Th. Eng. Start | Starting | Starting | On (Starter) | On (Starter) | Engaged | Engaged | Engaged | Engaged |
| Takeoff | On | On | On | On | Engaged | Engaged | Engaged | Engaged |
| Climb | On | On | On | On | Engaged | Engaged | Engaged | Engaged |
| Cruise #1 | On | On | On | On | Engaged | Engaged | Engaged | Engaged |
| Cruise #2 | On | On | Off | Off | Disengaged | Engaged | Engaged | Disengaged |

Failure Conditions

| | | | | | | | | |
|---|---|---|---|---|---|---|---|---|
| TE1 Inop | Inoperative | On | On | On | Engaged | Disengaged | Engaged | Engaged |
| TE2 Inop | On | Inoperative | On | On | Engaged | Engaged | Disengaged | Engaged |
| Prop 1 Inop | Off | On | Off | On | Disengaged | Disengaged | Engaged | Engaged |
| EM1 Inop | On | On | Inoperative | On | Disengaged | Engaged | Engaged | Engaged |
| Prop 2 Inop | On | Off | On | Off | Engaged | Engaged | Disengaged | Disengaged |
| EM2 Inop | On | On | On | Inoperative | Engaged | Engaged | Engaged | Disengaged |

FIGS. 7A & 7B respectively show an example hardware block diagram and a software flowchart relating to control structures and operations performed by example embodiments. Instructions stored in non-transitory memory may be executed by the FIG. 7A processor to perform the operations FIG. 7B shows. The FIG. 7B flowchart shows a loop that continually tests for inputs from sensors/pilots/remote and generate mode control outputs in response to such inputs. If a failure mode is detected, the processor generates failure control signals. The mode and failure control signals may be as described in the Tables above and shown in FIGS. 3A, 5A & 6A.

All patents and patent applications cited above are incorporated herein by reference.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An aircraft with an aft-fuselage propulsion system, comprising:
a thermal engine,
a first electric motor, housed within a nacelle, coupled to a first propulsor,
a second electric motor, also housed within a nacelle, coupled to a second propulsor,
a mechanical interlink system integrating the thermal engine, the first electric motor, the second electric motor, plural battery systems and associated power electronics, and cabling elements connecting the electric machines.

2. The aircraft of claim 1 wherein the thermal engine comprises a Diesel cycle engine or compression-ignition engines.

3. The aircraft of claim 1 wherein the mechanical interlink system comprises driveshafts and selective coupling devices.

4. The aircraft of claim 1 wherein each propulsor is coupled to the thermal engine through first and second gearboxes, one of the first and second gearboxes selectively coupling an associated on the first and second electric motors to said propulsor.

5. The aircraft of claim 1 wherein a first electric motor output shaft is directly attached to the first propulsor, a second electric motor output shaft is directly attached to the second propulsor, and the mechanical interlink system selectively couples the thermal engine to each of the first and second electric motors.

6. The aircraft of claim 1 further including:
a first selective coupling device that selectively couples the first electric motor to the first propulsor via a first gearbox connected to the first propulsor, and
a second selective coupling device that selectively couples the second electric motor to the second propulsor via a second gearbox connected to the second propulsor, and respective selective coupling devices that selectively couple the first and second gearboxes to the thermal engine.

7. An aircraft with plural mirrored aft-fuselage propulsion systems, each aft-fuselage propulsion system comprising:
a thermal engine,
an electric motor, housed within a nacelle,
a propulsor, and
a mechanical interlink system integrating the thermal engine, electric motor, and propulsor elements.

8. The aircraft of claim 7 wherein the mechanical interlink system comprises driveshafts and selective coupling devices, such as clutches.

9. The aircraft of claim 7 further comprising a battery system and associated power electronics, and cabling elements connecting electric components.

10. The aircraft of claim 7 wherein the thermal engine comprises a diesel piston engine or compression-ignition engines and the electric motor comprises an electric motor.

11. The aircraft of claim 7 wherein each aft-fuselage propulsion system further comprises first and second gearboxes coupled to one another via a selective coupling device, the first gearbox connected to a thermal engine output, the second gearbox connected between the electric motor and the propulsor.

12. The aircraft of claim 11 further comprising a selective coupling device that selectively couples the first gearbox to the second gearbox.

13. The aircraft of claim 11 further comprising a selective coupling device that selectively couples the electric motor to the second gearbox.

14. A method of controlling and operating an aircraft propulsion system comprising:
controlling nacelle electric motors to apply power to respective propulsors for taxiing;
for takeoff and climb, applying thermal engine output power to each of the respective propulsors to supplement the power the nacelle electric motors apply; and
for cruise, selecting between thermal engine output power and electric motor power to apply to the respective propulsors.
